(19) United States
(12) Patent Application Publication
(10) Pub. No.: US 2010/0294665 A1
(43) Pub. Date: Nov. 25, 2010

(54) METHOD AND SYSTEM FOR TRANSFERRING AND/OR CONCENTRATING A SAMPLE

(76) Inventors: Richard Allen, San Carlos, CA (US); Randall E. Burton, Billerica, MA (US); Bryan Crane, San Diego, CA (US); Jeffrey R. Krogmeier, Stoneham, MA (US); Jonathan W. Larson, Chelsea, MA (US); Vyacheslav Papkov, Waltham, MA (US); Nicaulas Sabourin, Ottawa (CA); Qun Zhong, Lexington, MA (US); Yi Zhou, Carlisle, MA (US)

Correspondence Address: WOLF GREENFIELD & SACKS, P.C., 600 ATLANTIC AVENUE, BOSTON, MA, 02210-2206, US

(21) Appl. No.: 12/668,579

(22) PCT Filed: Jul. 11, 2008
(86) PCT No.: PCT/US08/08530

§ 371 Date: Jul. 21, 2010

Related U.S. Application Data
(60) Provisional application No. 60/959,302, filed on Jul. 12, 2007.

(51) Int. Cl. G01N 27/447

(52) U.S. Cl. 204/520; 204/627

(57) ABSTRACT

A system for transferring and/or concentrating a sample is provided. The system includes a chamber with a membrane brave positioned within the chamber. An electrode assembly is configured to create an electric field across the membrane to move a charged sample through the chamber such that the sample collects and may concentrate on the membrane. The system may include a plurality of membranes. The system may also include a plurality of microchannels outwardly extending from the channel, where the membrane extends along the plurality of microchannels. Aspects of the invention are also directed to a pipette which may be used to transfer and concentrate a sample on a membrane. Certain embodiments are directed to methods and systems for concentrating a nucleic acid sample.

### FEDERALLY SPONSORED RESEARCH

This invention was made with Government support under U.S. Department of Homeland Security, Science & Technology Directorate contract HSHQPA-05-9-0019. The Government has certain rights to this invention.

### FIELD OF THE INVENTION

Aspects of the invention relate to methods and systems for transferring and/or concentrating a sample and more particularly to systems and methods which utilize an electric field to transfer and/or concentrate the sample.

### BACKGROUND OF THE INVENTION

When analyzing a biomaterial sample, such as a nucleic acid sample, there is often a need to transfer and/or concentrate the sample. Some prior approaches to transferring or concentrating a sample utilize a mechanical pump to hydrodynamically move and concentrate the sample. However, many types of nucleic acid samples are fragile and some mechanical approaches may damage the sample.

Other approaches utilize an electric field to concentrate a nucleic acid sample. However, an electric field may also damage a sample. For example, an electric field is created by the flow of current which may cause the temperature to increase in areas of greater electrical resistance. This is known as joule heating and it may damage the sample.

### SUMMARY OF INVENTION

Aspects of the present invention are directed to improved methods and systems for transferring and/or concentrating a sample while minimizing sample damage.

In one illustrative embodiment, a system for concentrating a sample is provided. The system includes a first concentrator and a second concentrator positioned downstream of the first concentrator. The first concentrator includes a first chamber, a first semi-permeable membrane positioned within the first chamber having a first sample contacting surface, and an electrode assembly configured to selectively create an electric field across the first membrane to move a sample at least partially through the first chamber, from a starting position to the first sample contacting surface. The second concentrator includes a second chamber in selective fluid communication with the first chamber, and a second semi-permeable membrane positioned within the second chamber having a second sample contacting surface. The electrode assembly is also configured to selectively create an electric field across the second membrane to move a sample at least partially through the second chamber from an intermediate position to the second sample contacting surface, where the area of the first sample contacting surface of the first membrane is greater than the area of the second sample contacting surface of the second membrane.

In another illustrative embodiment, a system for concentrating a sample is provided. The system includes a chamber having an inlet port, a plurality of substantially parallel microchannels outwardly extending from the channel, and a semi-permeable membrane extending within the chamber. The membrane has a first sample contacting surface and the membrane extends along the plurality of microchannels. The system further includes an electrode assembly configured to selectively create an electric field through the plurality of microchannels and across the membrane to move a sample at least partially through the chamber, from a starting position to the first sample contacting surface of the membrane.

In yet another illustrative embodiment, a pipette is provided. The pipette includes a body having a passageway therethrough, where the body has a first end and a second end, and a semi-permeable membrane is positioned within the passageway, where the semi-permeable membrane is spaced apart from the first end of the body. A conductive buffer solution is within the passageway, and a positive electrode is at the second end of the body, where the positive electrode may selectively create an electric field through the passageway to the first end of the body when used in association with a negative electrode.

In a further illustrative embodiment, a method of transferring and concentrating a sample is provided. The method includes the acts of providing a pipette having a body with a passageway therethrough, a semi-permeable membrane positioned within the passageway, and a electrolytic buffer solution within the passageway, and placing a first end of the pipette in contact with a negatively charged sample contained within a reservoir. An electric field is created through the passageway of the pipette body such that a first portion of the negatively charged sample is drawn into a first end of the pipette body, whereby the concentration of the first portion of the sample is greater than the concentration of the sample in the reservoir.

In yet another illustrative embodiment, a system for transferring a sample is provided. The system includes a first chamber, a first semi-permeable membrane positioned within the first chamber, where the first membrane has a first sample contacting surface, and an assembly configured to move a sample at least partially through the first chamber, from a starting position to the first sample contacting surface. The system further includes a second chamber, where the second chamber is in selective fluid communication with the first chamber and a second semi-permeable membrane positioned within the second chamber, where the second membrane has a second sample contacting surface. The assembly is also configured to move a sample at least partially through the second chamber from an intermediate position to the second sample contacting surface, where the assembly includes an electrode assembly configured to selectively create an electric field across the second membrane to move a sample to the second sample contacting surface, and the area of the first sample contacting surface is greater than the area of the second sample contacting surface.

In a further illustrative embodiment, a method of transferring and concentrating a sample is provided. The method includes the acts of providing a chamber with a semi-permeable membrane positioned within the chamber, with the membrane having a sample contacting surface, and a channel opposing the sample contacting surface, and placing a negatively charged sample within the chamber. An electric field is created across the membrane such that the negatively charged sample is drawn through the chamber and to the sample contacting surface of the membrane, and an electric field is then created into the channel opposing the sample contacting surface to move the negatively charged sample away from the sample contacting surface and towards the channel. Then, an electric field is created between the chamber and the channel to compress the sample in the chamber.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below with reference to the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1 is a schematic representation of a system for processing a sample according to one illustrative embodiment;

FIG. 2 is a schematic representation of a system for concentrating a sample according to another illustrative embodiment;

FIGS. 3A-3B are schematic representations of other systems for concentrating a sample according to another illustrative embodiment;

FIG. 4A-4C are schematic representations of a mechanical anchoring system according to one illustrative embodiment;

FIG. 5 is a schematic representation of another system for concentrating a sample according to yet another illustrative embodiment;

FIG. 6 is a schematic representation of another system for concentrating a sample according to another illustrative embodiment;

FIG. 7 is a schematic representation of yet another system for concentrating a sample according to another illustrative embodiment;

FIGS. 8A-8D are schematic representations of a squeeze mode elution process according to another illustrative embodiment;

FIG. 9A-9B and 10A-10B are schematic representations of the cone angle in a chamber according to one illustrative embodiment;

FIGS. 11A-11B are schematic representations of another system for concentrating a sample according to another illustrative embodiment;

FIGS. 12 and 13 are schematic representations of systems for transferring a sample according to a couple of illustrative embodiments; and

FIG. 14 is a schematic representation of a pipette according to one illustrative embodiment.

### DETAILED DESCRIPTION

Aspects of the invention are directed to systems and methods for transferring and/or concentrating a sample. The systems and methods may be employed with various types of samples including charged particles and/or biomaterials, and may, for example, be incorporated into biodefense applications and other single molecule biology applications. In some embodiments, the systems and methods may be used to transfer and/or concentrate a nucleic acid sample. The systems and methods may be used to concentrate DNA samples and/or RNA samples. In other embodiments, the systems and methods may be used to transfer and/or concentrate other types of samples, such as proteins and/or any negatively-charged polymer. It should be appreciated that in some embodiments, the systems and methods may be used to transfer and/or concentrate one or more components in the sample. The systems may be configured in any of numerous ways, and the present invention is not limited to the particular systems described below. Furthermore, it should be appreciated that the below described methods for transferring and/or concentrating a sample are not limited to be performed only with the various systems described below. Furthermore, it is also contemplated that the below described methods and systems could be used to determine the presence and/or absence of a nucleic acid sample.

The systems and methods for transferring and/or concentrating a sample utilize an electric field. The sample may include negatively charged particles, such as, for example, nucleic acids, diluted within a buffer solution. When an electric field is created between a positive electrode and a negative electrode, the negatively charged particles in the sample are electrically attracted toward the positive electrode. In certain embodiments, the buffer solution is less attracted towards the electrodes.

The system for concentrating a sample may include a chamber with at least one membrane. To concentrate the sample, the sample is placed within the chamber and an electric field is created across the membrane such that the negatively charged sample moves toward the positive electrode. In one embodiment, the membrane may be positioned between the sample and the positive electrode such that the negatively charged sample will collect and concentrate on the membrane. In another embodiment, the membrane may be positioned between the sample and the negative electrode, for example, when the sample is eluted from the membrane after concentration.

Certain aspects of the invention are directed to systems and methods for concentrating a sample with an electric field having a substantially uniform current density across the membrane. In an electric field, negatively charged particles/molecules (such as nucleic acids) will follow the path of least resistance (i.e. current streamlines) towards the positive electrode. When a substantially uniform current density is created across the membrane, the sample may collect more evenly across the membrane. Without a substantially uniform current density across the membrane, the particles may tend to pile up more on portions of the membrane where there is a higher current. Then, the particles/molecules moving off the membrane may not travel at the same rate causing them to become more distributed in space, i.e. less concentrated.

As discussed in greater detail below, one approach to creating a substantially uniform current density across a membrane is to include a plurality of substantially parallel microchannels positioned between the membrane and the electrode such that the current travels through the microchannels. Such a configuration may alter the electrical resistance which may force current streamlines to spread uniformly across the width of the membrane. The electric field may be substantially evenly distributed through the microchannels to provide a substantially uniform current density across the membrane.

Another approach to creating a substantially uniform current density across a membrane, which is discussed in greater detail below, is to include a shallow depth region positioned between the membrane and the electrode. The shallow depth region may alter the electrical resistance which may force current streamlines to spread more uniformly across the width of the membrane.

In certain embodiments, the system for concentrating may be formed into a microfluidic chip. Microfluidic chips are structures designed for processing small fluid samples. Microfluidic chips may be stacked on top of each other and/or along side one another with fluid ports connecting adjacent chips. Each microfluidic chip may include one or more passageways so that a fluid sample may travel through the chip for various types of analyses.

In some embodiments where a chamber is formed in a microchip, the geometry of the chamber may be constrained by shallow etch depth microlithographic manufacturing techniques. A minimum surface area may be required for a particular embodiment, (for example, the need to avoid joule heating can cause the minimum membrane area within a chamber to be high). Achieving this minimum area given manufacturing constraints may require low aspect ratio features (for example, 500:1). This area may be coupled to another device or chamber via a higher aspect ratio channel (for example, 5:1). Certain aspects of the invention are directed to systems and methods for concentrating a sample having a substantially uniform current density across the membrane in such chamber geometries with low aspect ratios.

In other embodiments, the systems and methods for concentrating a sample may utilize a pipette. The pipette may also be used to transfer a sample from one location to another. A pipette may be used to transfer a sample between two locations that are not in fluid communication with each other (i.e. remote), for example, between two spaced apart reservoirs. As discussed in more detail below, the pipette includes a passageway with a semi-permeable membrane positioned within the passageway. According to one method, a first end of the pipette is placed in contact with a negatively charged sample contained within a reservoir. An electric field is created through the pipette passageway such that a first portion of the negatively charged sample is drawn into the first end of the pipette body to concentrate the first portion of the sample in the pipette.

Further aspects of the invention are directed to systems and methods for concentrating a sample which minimize damage to the sample. For example, in one embodiment, systems and methods for concentrating a nucleic acid sample are provided which are designed to minimize and/or eliminate damage to the nucleic acids which may occur due to shear forces acting on the nucleic acids. Such methods and systems are discussed in greater detail below and may be suitable for concentrating fragile nucleic acid samples, such as samples which include long DNA segments. Samples with long segments may be more apt to experience shear force damage while moving the sample. For example, in one embodiment, DNA segments having a length between approximately 100 kilobase to 1 megabase may be concentrated with the below described systems and methods without substantial shear damage. In some embodiments, the methods of the invention produce less than 1% shear damage. In other embodiments, the methods produce less than 20%, less than 10%, less than 5% or less than 2% shear damage. In other embodiments, systems and methods for concentrating a sample are provided which are designed to minimize and/or eliminate damage to the sample which may occur due to joule heating and temperature increases. Further embodiments are directed to systems and methods for concentrating a sample which are designed to minimize and/or eliminate damage to the sample which may occur due to harmful interactions between the sample and the membrane.

### Concentrator System

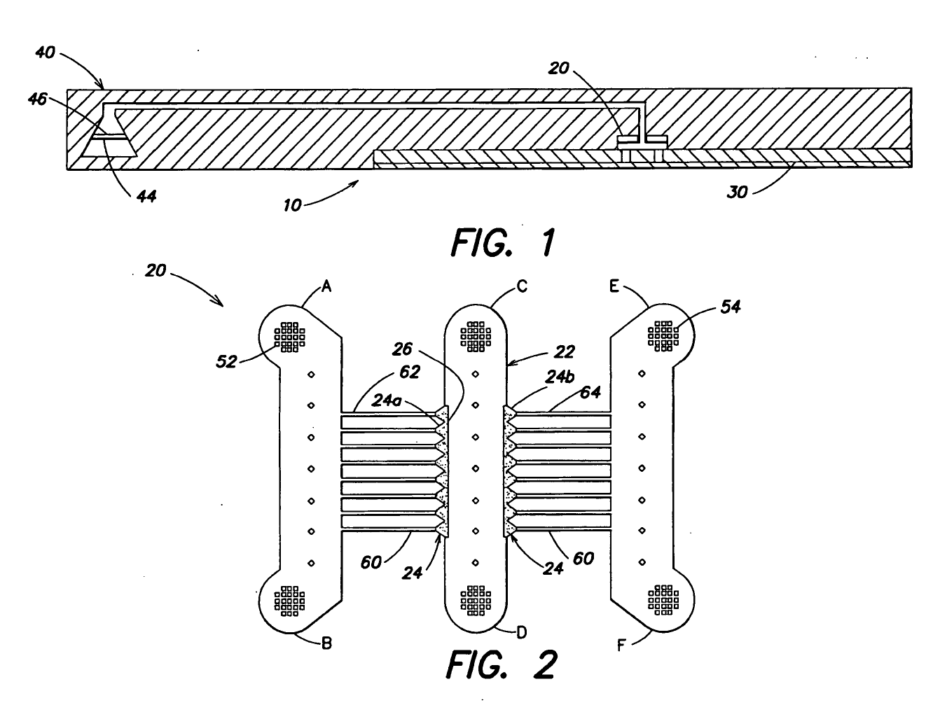

Turning to FIGS. 1-3, a schematic representation of a system 10 for concentrating a sample according to one embodiment is illustrated. In this particular embodiment, the system is a multi-stage concentrator system 10 having a plurality of systems including a first concentrator system 20 and a second concentrator system 30 which are in fluid communication with each other, where the second concentrator system 30 is positioned downstream of the first concentrator system 20.

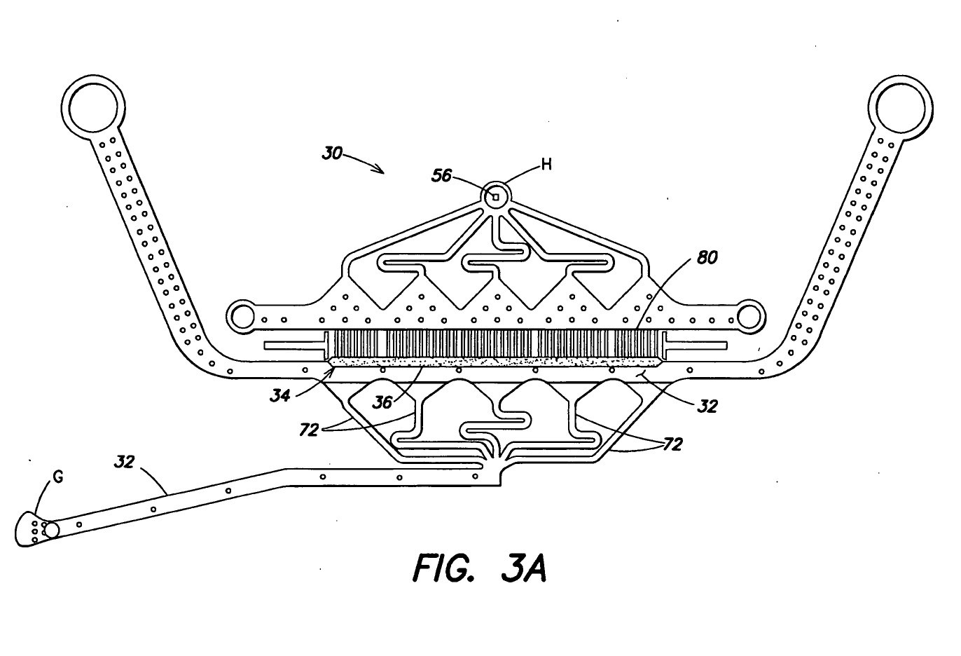

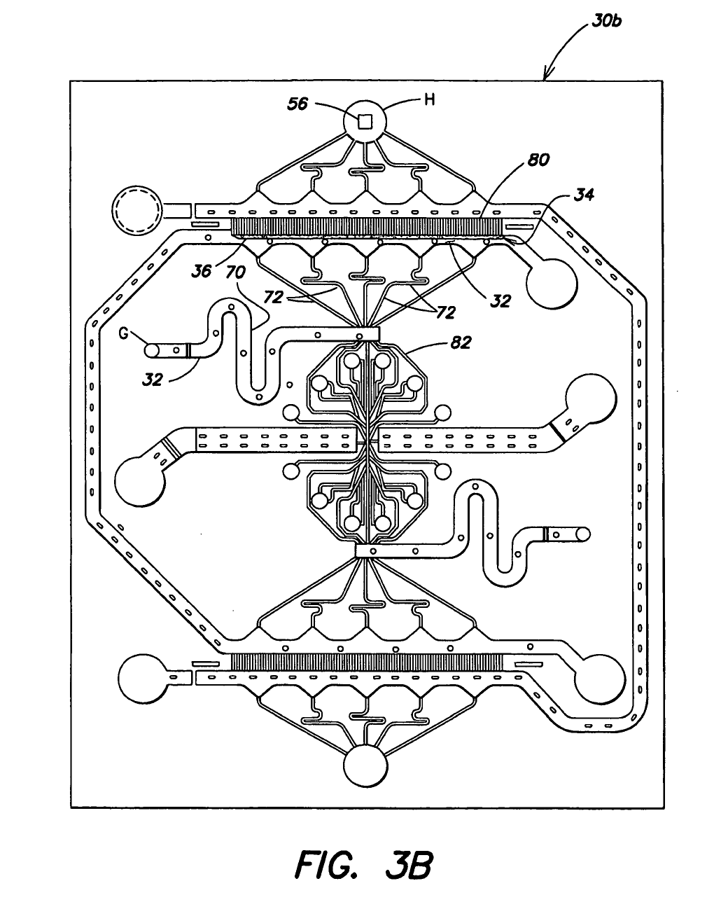

The first and second concentrator systems 20, 30 according to one embodiment of the invention are shown in greater detail in FIGS. 2 and 3A. The first concentrator system includes a first chamber 22 with a first semi-permeable membrane 24 positioned within the chamber 22, and the second concentrator system 30 includes a second chamber 32 with a second semi-permeable membrane 34 positioned within the chamber 32. The first semi-permeable membrane 24 has a first sample contacting surface 26 and the second semi-permeable membrane 34 has a second sample contacting surface 36. The geometry and chemical nature of the surface of the semi-permeable membranes 24, 34 that come into contact with the sample (i.e. the first and second sample contacting surfaces 26, 36) may vary in different embodiments of the present invention. These sample-contacting surfaces, 26, 36 may be designed to accommodate the throughput and concentration needs of a particular system 10 and may be modified to allow for efficient elution of the sample from the membrane after concentration.

An electrode assembly (discussed in greater detail below) is configured to selectively create an electric field across the first and second membranes 24, 34 to move a sample through the concentrator systems 20, 30. The first and second concentrator systems may be filled with a fluid buffer such as Tris/Borate/EDTA(TBE) or Tris/Acetate/EDTA(TAE) to facilitate movement of the sample through the systems. In one embodiment, the first and second concentrator systems are filled with a buffering system stable under high electric fields for prolonged periods. The fluid must be an electrolytic (i.e. conductive) so that the electric field extends through the fluid to move a sample. In one embodiment, the fluid buffer has a sodium chloride concentration of approximately 20 millimolar.

An electric field may be created across the first membrane 24 to move a sample at least partially through the first chamber 22 from a starting position to the first sample contacting surface 26 on the first membrane 24. In one embodiment, the starting position is outside of the first chamber 22 and may, for example, be on a membrane 44 in a reaction chamber 40 which is positioned upstream of the first concentrator system 20. For example, in one illustrative embodiment, the sample may initially be positioned on a cellulose starting membrane 44 within the reaction chamber 40. Various types of sample preparation processes such as lysis, digestion, intercalation, nucleic acid extraction, uniform or sequence-specific labeling, and buffer exchanges may be performed within the upstream reaction chamber 40.

The second chamber 32 of the second concentrator system 30 is in selective fluid communication with the first chamber 22 of the first concentrator system 20. The electrode assembly is configured to selectively create an electric field to move the sample from the first chamber 22 at least partially through the second chamber 32. The electrode assembly may create an electric field across the second membrane 34 to move the sample from an intermediate position to the second sample contacting surface 36 on the second membrane 34.

In one embodiment, the first membrane 24 is smaller than the starting membrane 44, and the second membrane 34 is smaller than the first membrane 24, so that the concentration of the sample which collects on these membranes 44, 24, 34 increases through each stage of the system 10.

The electric field is created within a chamber when current flows through the chamber. At a substantially constant current, the strength of the electric field will vary with the cross-sectional area of the chamber. In general, the strength of an electric field within the chamber increases as the cross-sectional area of a chamber decreases. In one embodiment, where the second membrane 34 is smaller than the first membrane 24, the strength of the electric field may increase through the system 10 from the first membrane 24 in the first concentrator system 20 to the second smaller membrane 34 in the second concentrator system 30.

In some embodiments, it is desirable for the charged particles/molecules in the sample to move faster through the chamber. This allows for faster processing of a sample and/or larger volumes of samples to be concentrated. As the strength of the electric field increases, the speed of the negatively charged particles through the chamber towards a positive electrode may also increase. Conversely, when the electric field is weak, the particles may move more slowly through the chamber.

However, as the strength of the electric field increases, the sample may be damaged due to the increase in electric field. As the current travels through a concentrator system, portions of the concentrator system may heat up as a result of resistance in the flow of current. This is a concept known as joule heating and this heat may damage the sample. Joule heating may damage a sample, such as a DNA sample, by denaturing the DNA strands, by the release of bonds that retain the dye or tags, and/or by damaging the fluorescence mechanisms of the dye or tags. Independent of joule heating, an increase in electric field may also cause damage by creating an excessive force along the polymer chain on a tethered molecule in a uniform field and/or by creating an excessive force along the polymer chain in a free solution due to an electric field gradient.

Aspects of the present invention are directed to a multi-stage concentrator system which helps to balance the benefits of a stronger electric field, while reducing the amount of damage to the sample. In one embodiment, the electric field strength may be chosen such that the charged particles/molecules may move faster to the first membrane 24 than to the second downstream membrane 34. For example, in one embodiment of a multi-stage concentrator system, the area of the starting membrane contacting surface 46 in the reaction chamber 40 is greater than the area of the first sample contacting surface 26, and the area of the first sample contacting surface 26 is greater than the area of the second sample contacting surface 36. A first electric field may be used to move the sample from the starting membrane contacting surface 46 to the first sample contacting surface 26. A second weaker electric field may then be used to move the sample to the second smaller sample contacting surface 36. In one embodiment, the applied voltage is between approximately 500-1000 volts. In another embodiment, the applied voltage is between approximately 100-200 volts.

The first and second electric fields may be chosen in a manner which minimizes damage of the samples caused by the electric field. Without a multi-stage concentrator system, the maximum electric field strength may be based upon the smallest membrane configuration of the overall system 10, so as to prevent damage to the sample which may be caused by the electric field. With a multi-stage concentrator system, a maximum electric field strength may be different for each concentrator system 20, 30, allowing the sample to move and thus concentrate at different rates based upon the size and configuration of each stage. More specifically the electric field may be stronger in stages where the area of the membrane contacting surface is larger. Thus, the speed of the sample to the first membrane 24 may be greater than the speed of the same sample to the second membrane 34.

In one embodiment, the ratio between the first sample contacting surface 26 and the second sample contacting surface is approximately 2. In another embodiment, the ratio between the first sample contacting surface 26 and the second sample contacting surface is approximately 10, and in yet another embodiment, the ratio between the first sample contacting surface 26 and the second sample contacting surface is approximately 20. For example, in one exemplary embodiment the area of the first sample contacting surface 26 of the first membrane 24 is approximately 0.4 mm². From the first membrane 24, the sample is moved to the second membrane 34 where the area of the second sample contacting surface 36 of the second membrane 34 is approximately 0.02 mm².

In one embodiment, the ratio between the area of the starting membrane 44 in the reaction chamber and the area of the first sample contacting surface 26 is approximately 100, and in another embodiment, the ratio between the area of the starting membrane 44 and the area of the first sample contacting surface 26 is approximately 250. For example, in an embodiment where the first sample contacting surface 26 is approximately 0.4 mm², the area of the starting membrane 44 in the reaction chamber may be approximately 100 mm².

It should be appreciated that aspects of the present invention are directed to multi-stage concentrators which may include three, four or more concentrator systems (not shown) which may be in fluid communication with and positioned downstream of the first and second concentrators systems 20, 30. Each concentrator system may include a membrane, where the area of the sample contacting surface of the membrane is smaller than the membrane in the upstream concentrator system. The number of concentrator systems in a multi-stage concentrator system may vary based upon the geometry of the overall system, the heat dissipation characteristics, and the desired concentration time.

FIG. 2 illustrates the first concentrator system 20 according to one embodiment of the present invention in greater detail. As discussed above, this concentrator system 20 includes a chamber 22 with a first membrane 24. As illustrated, in some embodiments, the first membrane 24 is formed of a plurality of portions, 24a and 24b which may extend along opposite sides of the chamber 22. As discussed below, one or both portions 24a, 24b of the membrane 24 may be used to concentrate the sample, depending upon how the electric field is created. In this particular embodiment, the concentrator system 20 includes six ports A-F in selective fluid communication with the chamber 20. In this embodiment, port C is in fluid communication with the upstream reaction chamber 40, and thus port C may be defined as the inlet into the chamber 20. Port D may be defined as the chamber outlet, and port D may be in fluid communication with the downstream second concentrator system 30. In other words, the sample may move from the starting membrane 44 in the reaction chamber 40 to the first membrane 24 though port C. After the sample collects and concentrates on the first membrane 24, the sample may move through port D and into the second concentrator system 30.

To create an electric field across the membrane portion 24a, the electrode assembly may include a first electrode 52 positioned within the concentrator system 20. For example, in one embodiment, a positive electrode may be positioned within port A and/or port B, and a negative electrode (not shown) may be positioned at a location upstream from the sample. When an electric field is created between the positive and negative electrodes, the negatively charged sample will move into the chamber, towards the positive electrode, and will collect and concentrate on the membrane portion 24a. The membrane 24 is configured such that the sample cannot easily pass through the membrane so that the sample collects on the sample contacting surface 26.

In one embodiment, the concentrator system 20 includes a plurality of substantially parallel microchannels 60 extending outwardly from at least a portion of the channel 20. As shown, in this particular embodiment, a first set 62 of substantially parallel microchannels 60 extends outwardly from one portion of the channel 22 and a second set 64 of substantially parallel microchannels 60 extends outwardly from another spaced apart portion of the channel 22. In this embodiment, the first and second sets 62, 64 of microchannels extend along opposite sides of the chamber 22 and the two portions 24a, 24b of the first membrane 24 extend along the length of the first and second sets 62, 64 of microchannels, respectively.

As discussed above, aspects of the present invention are directed to systems and methods for concentrating a sample with an electric field which creates a substantially uniform current density across the membrane. The above-described substantially parallel microchannels 62 which are proximate to the membrane portion 24a may provide a substantially uniform current density across the membrane 24a, such that the sample may collect and concentrate more evenly across the membrane 24a. In particular, the current travels through the microchannels such that the current density across the membrane is substantially uniform.

To create an electric field across the membrane portion 24b, the electrode assembly may include a positive electrode 54, which may for example, be positioned within port E and/or port F. When an electric field is created between the positive electrode and an upstream negative electrode, the sample will move into the chamber 22 towards the positive electrode 54 collecting and concentrating on the membrane 24b. With the second set of substantially parallel microchannels 64 which are proximate to the membrane portion 24b, a substantially uniform current density across the membrane 24b may be provided, so that the sample may collect and concentrate substantially evenly across the membrane 24b.

It should be appreciated that in some embodiments, the sample may collect and concentrate on either one or both of the membrane portions 24a, 24b. In one embodiment, an electric field may be created across both membrane portions 24a, 24b, such that the sample may collect simultaneously on the membrane portions 24a, 24b. In another embodiment, the electric field across the membrane portions 24a, 24b may be created sequentially, such that a first portion of the sample is concentrated onto membrane portion 24a, and thereafter a second portion of the sample is concentrated onto membrane portion 24b.

In addition to creating a more uniform current density across the membrane 24, the plurality of microchannels 60 may also enable the fabrication of larger membrane surfaces by providing a greater surface to which the membrane 24 may attach. The greater surface area which may be provided by the microchannels 60 may make the membrane 24 more secure within the chamber 22 when the membrane 24 is subjected to pressure gradients and/or electrical gradients.

Turning now to FIGS. 3A and 3B, two embodiments of the second stage concentrator system 30, 30b are illustrated in greater detail. In certain embodiments, the sample exits the first stage concentrator 20 through port D (FIG. 2) and enters the second stage concentrator through port G. As shown in FIG. 1, in one embodiment, the two concentrator systems 20, 30 may be stacked one on top of the other and port D in the first concentrator 20 may be aligned with port G on the second concentrator 30, 30b. Once in the second chamber 32, the sample may move through a serpentine portion 70 (see FIG. 3B) branching out into five channels 72 which end at the second membrane 34. The sample may move towards the second membrane 34 due to an electric field which may be created due to a positive electrode 56 positioned at port H and a negative electrode in a position upstream from the sample, such as at port D (see FIG. 2).

Similar to the membrane 24, a plurality of microchannels 80 are shown proximate the second membrane 34. This configuration may provide an electric field which creates a substantially uniform current density across the membrane 34 such that the sample may collect and concentrate more evenly across the sample contacting surface 36.

Although the schematic representation of concentrators illustrated in FIGS. 2, 3A and 3B are not drawn to scale, it should be recognized that in some embodiments, the area of the second sample contacting surface 36 of the second membrane 34 is smaller than the area of the first sample contacting surface 26 of the first membrane 24. To prevent damage to the sample, the current and electric field strength may be lower while moving the sample through the second concentrator system 30 in comparison to the voltage and electric field strength while moving the sample through the first concentrator system 20.

Once the sample collects and concentrates on the second membrane 34, the electric field may be reversed so that the sample moves in the opposite direction. In one embodiment, the positive electrode 56 positioned at port H may be replaced with a negative electrode to repel the negatively charged sample back through the five channels 72. At this stage, the sample may either be moved into another concentrator (not shown) for further concentration or the sample may undergo further processing which may depend upon the type of sample. In one embodiment, where the sample is a nucleic acid sample including DNA, the sample may move into a reaction chamber 82 (see FIG. 3B) where the DNA may, for example, be stretched to obtain DNA sequence information.

As shown in FIG. 3B, in one embodiment, the second concentrator 30b is configured on a microfluidic chip where one portion is substantially the mirror image of another portion. In this particular illustrated embodiment, the top portion is a mirror image of the bottom portion. This configuration enables the simultaneous concentration of two samples on the same microfluidic chip, which may result in higher sample throughput within a given space constraints. It should be recognized that in other embodiments, the concentrator system 30, 30b may be configured differently, as the invention is not so limited.

The concentrator systems 20, 30, 30b may be formed in a variety of ways, as the invention is not limited in this respect. The concentrator systems 20, 30, 30b may be formed of materials such as, but not limited to, plastic, glass (fused silica, borosolicate, etc.), insulated semiconductors (silicon dioxide on silicon, etc), or ceramics. In one embodiment, the concentrator systems 20, 30 are formed onto a microfluidic chip, where the channels 22, 32 and/or the microchannels 60, 80 may be pre-etched into the chip. As shown in FIG. 1, in one embodiment, the first concentrator system 20 is formed into a first microfluidic chip and the second concentrator system 30 is formed into a second microfluidic chip. It should be appreciated that in other embodiments of a multi-stage concentrator system, the first and second concentrator systems 20, 30 may be formed into the same microfluidic chip. In one embodiment, one or more concentrator systems are formed onto a microfluidic chip having a thickness of approximately 20 microns.

The membranes 24, 34 are conductive, such that an electric field may travel through the membranes. The membranes are semi-permeable and may be porous, but the membranes are configured such that the sample cannot easily pass completely through the membranes 24, 34. As discussed further below, the membranes 24, 34 may be configured such that a sample may pass partially into but not completely through the membranes, such that the sample becomes embedded within the membrane. However, in other embodiments, the membranes 24, 34 may be configured such that the sample cannot penetrate the sample contacting surface 26, 36. In one embodiment, the membranes 24, 34 may be formed from a semi-solid material, and may for example, be made from a dense polymer matrix.

The membranes 24, 34 may also be formed in a variety of ways. In one embodiment, a membrane is a semi-permeable polymer membrane formed from a material such as an acrylimide, polyacrylimide, agarose, polyethylene glycol (PEG), and/or other biocompatible gel, and may for example be formed from a mixture of both acrylimide and PEG. In another embodiment, one or both of the membranes may be formed from a cellulose membrane, such as a cellulose filter paper.

Hybrid designs, including at least two different types of semi-permeable membranes, are also contemplated as the present invention is not limited in this respect.

For example, in one embodiment, the first membrane 24 may be made of a regenerated cellulose membrane, and another membrane, such as the second membrane 34, may be made of a gel.

It is also contemplated that in certain embodiments, the membrane material may be formed to have a particular configuration and/or pore size to substantially limit the collection and/or concentration of nucleic acids having a certain particle size. In this respect, the membrane material may be configured to have a particular cut-off nucleic acid size. This fractionation functionality may be beneficial when the concentration of only longer and/or larger nucleic acids is desirable, as the shorter and/or smaller nucleic acids may either pass through the membrane or become embedded within the membrane.

In one embodiment, the membrane 24 may be fabricated with a gel, such as an acrylimide gel or agarose gel. To form the membrane 24, the chamber and microchannels of the microfluidic chip may first be filled with the gel. The gel may include a photo initiator such that when UV light is selectively exposed to portions of the gel, the gel crosslinks and solidifies within the chamber 22, 32 to form the membrane 24, 34. In one embodiment, azo-based photo initiator such as VA-086 and/or VA-50 obtained from Wako Chemicals (Richmond, Va.) may be used. In another embodiment, a photo initiator called Darocur® obtained from Ciba Specialty Chemicals is used. In certain embodiments having the Darocur® photo initiator, the polymerization and solidification of the gel may occur more rapidly. Due to the small dimensions associated with a microfluidic chip, the chip may be placed under a microscope to selectively expose portions of the gel to the UV light. Once the desired portions of the gel are exposed to the UV light, the remaining unsolidified gel may be flushed out to the microfluidic chip using a fluid wash.

In some embodiments, before the microfluidic chip is filled with the gel, the microfluidic chip may first be flushed with a series of reagents, and/or a polymer coating, such as an acrylimide coating, may be used to coat the inner chamber and microchannel walls. This coating may form chemical bonds to act like an anchor for the gel so that the gel may bond more easily to the inner walls of the chamber and microchannels. Thereafter, the microfluidic chip may be flushed with water before introducing the gel into the chip to form the membrane.

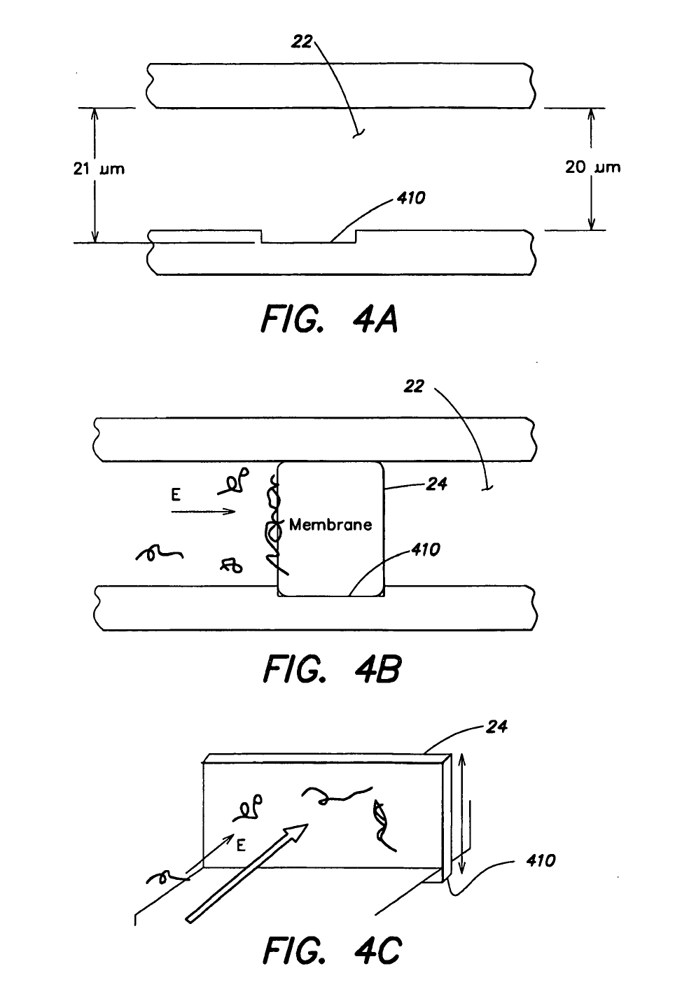

In certain embodiments, one or more chambers may be configured to act as a mechanical anchor to the gel membrane. In particular, the chamber may be provided with positive or negative relief areas. The membrane may be positioned adjacent these positive or negative relief areas to prevent the membranes from moving. One example of a negative relief in the chamber according to one embodiment is illustrated in FIGS. 4A-4C. In this particular embodiment, the chamber 22 includes a furrow 410 which acts as a foothold to anchor membrane 24. In this particular embodiment, the chamber is approximately 20 μm deep and the furrow 410 itself is approximately 1 μm deep, making the total depth of the chamber along the furrow 410 approximately 21 μm. This type of mechanical anchoring of the membrane may help to prevent the membrane from becoming dislodged under either hydrodynamic force or the electric field. Such a reinforced membrane may be better able to withstand high currents.

In other embodiments, a positive relief may be provided in a chamber 22 to mechanically anchor a membrane. In a positive relief, a protrusion is formed in the inner chamber walls to help secure the membrane. In one embodiment, a post may be formed in the channel and may extend from the floor to the ceiling.

In certain embodiments, a negative relief anchoring system may be preferred over a positive relied anchoring system because the protrusions/posts associated with a positive relief anchoring system may disrupt the electric field lines flowing through the chamber. In some embodiments, the currently density may be more uniform with a negative relief furrow 410 anchoring system in comparison to a positive relief protrusion anchoring system.

In certain embodiments, it may be desirable to limit the amount of the nucleic acid sample that may become embedded within the membrane. In such embodiments, a passivation process may be used to fill voids within the membrane so that the sample does not later become embedded within those voids. For example, in one embodiment with a gel membrane, a “sacrificial material” may be flushed through the system to fill up voids and/or pores within the membrane. The sacrificial material is typically a negatively charged material that is capable of filling voids/pores in the membrane. In one embodiment, where the nucleic acid sample is a DNA sample, the sacrificial material may include another type of DNA. The sacrificial material that does not become to embedded within the membrane is then flushed out. It is also contemplated that the sacrificial material may be a positively charged material if the material is capable of remaining in the membrane during a concentration step, which may utilize an electric field. A repassivation step may also be performed to reintroduce the sacrificial material into the membrane after prolonged use.

As discussed below, in certain embodiments as shown in FIG. 2, the solidified gel membrane 24, 34 may extend along and at least partially into the plurality of microchannels 60, 80. In other embodiments, the solidified gel membrane 24, 34 may extend adjacent to and along the length of the microchannels, and in yet another embodiment, the solidified gel membrane 24, 34 may extend along and spaced apart from the plurality of microchannels 60.

It should be recognized that the above description regarding the formation of the membrane 24, 34 within the concentrator systems 20, 30, 30b is not intended to be limiting, as the membrane may be formed with other materials and/or with other methods. Furthermore, it should be recognized that one membrane 24 within the first concentrator system 20 may be formed with different materials and/or according to different methods than another membrane 34 in the second concentrator system 30, 30b.

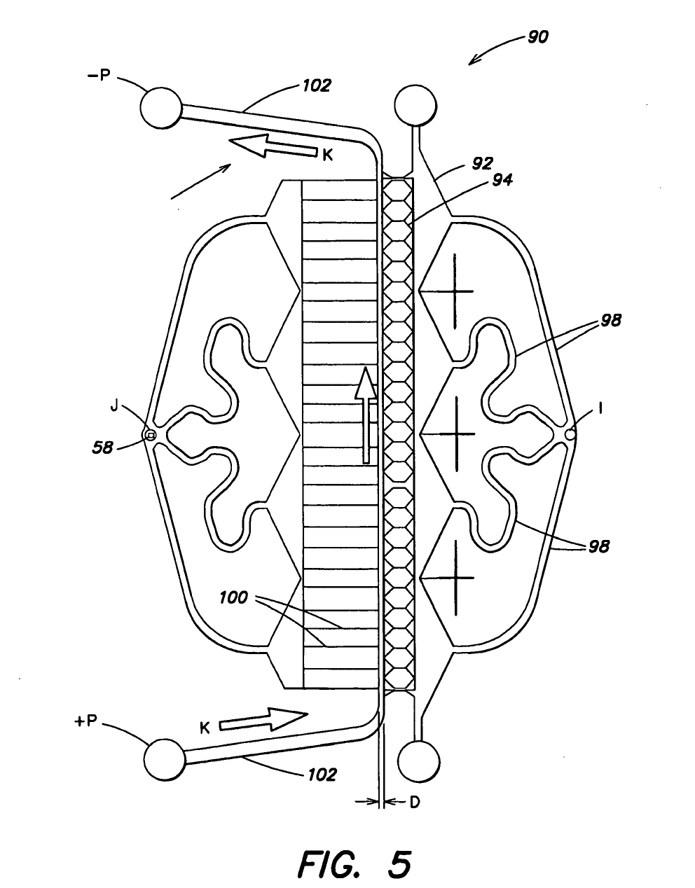

FIG. 5 illustrates yet another embodiment of a system for concentrating a sample. Similar to the above-described embodiments, this concentrator system 90 includes a chamber 92 with at least one semi-permeable membrane 94. A sample may enter the chamber 92 through inlet port I. Once in the chamber 92, the sample may move through and branch out into the four channels 98 which end at the membrane 94. As illustrated, the channels 98 may be shaped differently, but in one embodiment, the channels 98 are shaped such that each has approximately the same length. The negatively charged sample may move from port I towards the membrane 94 due to an electric field which may be created due to a positive electrode 58 positioned at port J and a negative electrode in a position upstream from the sample, such as at port I. Membrane 94 may be configured similar to the above-described membranes 24, 34 such that as the sample is attracted to the positive electrode 58 at port J, the sample collects and concentrates onto the membrane 94.

Similar to the above-described first and second membranes 24, 34, in the embodiment illustrated in FIG. 5, a plurality of microchannels 100 are along the length of and proximate to the membrane 94. This configuration may provide an electric field such that the current travels through the microchannels 100 which creates a substantially uniform current density across the membrane 94 such that the sample may collect and concentrate more evenly across the membrane 94.

Unlike the embodiments illustrated in FIGS. 2 and 3, the membrane 94 shown in FIG. 5 is spaced apart from the plurality of microchannels 100 by a distance D. When the membrane 94 is spaced apart from the microchannels 100, a fluid may flow along the membrane 94. This fluid flow may be referred to as backside flow. In one embodiment, a cooling fluid may flow through the concentrator system 90, as represented by arrows K, along the length of the membrane 94, with the fluid inlet and outlet being provided by backflow branches 102. It should be recognized that the concentrator systems 20, 30, 30b discussed above may be configured such that one or both of the membranes 24, 34 are spaced apart from microchannels 60, 80, as the invention is not so limited. Although the size of the separation distance D may vary based upon the size and configuration of the concentrator system 90, in one embodiment, distance D is approximately 800 micrometers.

There may be several benefits associated with embodiments where the membrane 94 is spaced apart from the plurality of microchannels 100. First, the separation distance between the membrane and the microchannels permits the flow of the cooling liquid to circulate behind the membrane 94 through the backside flow branch 102 which may reduce the affects of the joule heating. As the current travels through the membrane, the membrane 94 and the surrounding areas may heat up as a result of the increased resistance in the flow of current through the membrane. The flow of the cooling liquid behind the membrane 94 helps to reduce the affects of the joule heating. Second, when the membrane 94 is spaced apart from the microchannels, the membrane 94 does not extend into the microchannels which may also minimize joule heating. As mentioned above, as the current travels through a concentrator system, portions of the system may heat up as a result of resistance in the flow of current. As the current travels through the buffer fluid, the resistance may be minimal, but the resistance may increase as the current travels through the membranes 94. For example, the resistance through the membrane material may be between approximately 3 and 10 times greater in comparison to the resistance through the buffer fluid. This can lead to undesirable localized hot-spots in to the microchannels 100. When the microchannels 100 are spaced apart from the membrane 94, the microchannels 100 may be filled with a buffer fluid which has a lower resistance in comparison to the resistance of the membrane 94 which may minimize hot-spots. Third, the flow of cooling fluid along the membrane 94 may also prevent ion concentration polarization. In certain embodiments, the pore size of the membrane 94 may be small enough that it is difficult for ions to move through the membrane 94. Ion concentration polarization may occur if ions build up on one side of the membrane. Over time, ion concentration polarization can result in an undesirable current drop. The flow of liquid adjacent the membrane through the backside flow branch 102 may reduce and/or prevent this ion build up and thus helps to stabilize the current.

As discussed above, to form the membrane 94, the gel may fill the microfluidic chip and thereafter only selected portions of the gel may be exposed to a UV light to crosslink and thereby solidify those gel portions. The non-crosslinked gel portions are then flushed out of the chip and filled with the buffer fluid. When the microchannels are filled with the gel rather than the buffer fluid, the resistance for the current to travel through the gel may be greater. Thus, in certain embodiments, the gel which may be used to form the membrane may be flushed out of the plurality of microchannels to reduce the affects of the joule heating within the concentrator system.

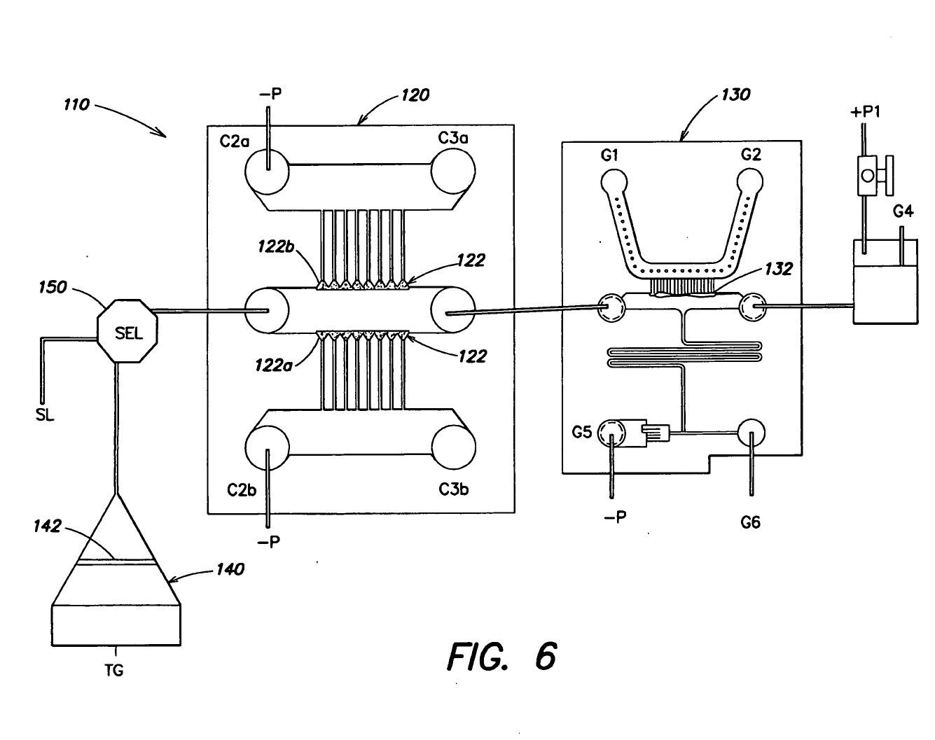

Turning now to FIG. 6, a schematic representation of another embodiment of a system 110 for concentrating a sample is illustrated. In particular, the embodiment illustrated in FIG. 6 illustrates an electrode assembly which includes a plurality of electrodes to selectively create an electric field within selected portions of the system to move a sample through the system 110. This system is a multi-stage concentrator system 110 having a first concentrator system 120 and a second concentrator system 130 which are in selective fluid communication with each other, where the second concentrator system 130 is positioned downstream of the first concentrator system 120. Similar to the concentrator systems discussed above, the first concentrator system 120 has a membrane 122 and the second concentrator system 130 has a second membrane 132 which are used to concentrate the sample. Similar to the embodiment disclosed in FIG. 1, a reaction chamber 140 is in selective fluid communication with and is positioned upstream from the first concentrator system 120. A selector valve 150 is positioned between the reaction chamber 140 and the first concentrator system 120.

A sample may initially be positioned on a starting membrane 142 within the reaction chamber 140. To initiate movement of the sample, an electric field may be created through electrodes SL and TG such that the electric field extends through the reaction chamber 140, but not through the first or second concentrator system 120, 130. For example, when electrode TG is a negative electrode and electrode SL is a positive electrode, the sample will travel away from the reaction chamber 140 and towards the selector valve 150.

In some embodiments, the membrane 122, 132 within the first and second concentrator systems 120, 130 may be more susceptible to joule heating damage. When an electric field is created between electrodes SL and TG, a greater current may be used to move the sample because this electric field is not created across either downstream membrane 122, 132. A greater current between electrodes SL and TG may thus be used to create a stronger electric field to free the sample from membrane entanglement with the starting membrane 142. As set forth above, a greater current may also make the sample move at a higher velocity.

Once the sample is removed from the starting membrane 142, the electric field may change. For example, the electric field may be created between electrodes C3a, C3b which may be positive electrodes, and electrode TG may be maintained as the negative electrode. In this respect, the sample travels into the first concentrator system 120 and collects and concentrates on the membrane 122. As discussed above with respect to FIG. 2, in certain embodiments, a membrane 122 may be formed of two portions, 122a and 122b which may extend along opposite sides. When an electric field is created with both electrodes C3a and C3b, both portions 122a, 122b of the membrane 122 may be used to concentrate the sample. It should be appreciated that each membrane 122a, 122b may be used independently, simultaneously, and/or sequentially to concentrate a sample depending upon how the electric field is created.

To move the sample from membrane 122a, 122b into the second concentrator system 130 an electric field may be created between electrodes C3a, C3b and downstream electrode G2. To move the sample towards electrode G2, electrode G2 may be a positive electrode and electrodes C3a, C3b may now be negative electrodes. In one embodiment, the sample on membrane portion 122a may be moved independent of a sample on membrane portion 122b. For example, an electric field may be created between electrode C3a and G2 to move the sample on membrane 122a, whereas an electric field may be created between electrodes C3b and G2 to move a sample on membrane 122b. The independent operation of membranes 122a,122b may allow one to create an electric field on only one membrane portion 122a or 122b which is strong enough to move a sample given the restraints of the current density on the second smaller downstream membrane 132 due to joule heating. Once the sample collects on membrane 132, an electric field may be created between electrodes G1, G2 and downstream electrode G4 to move the concentrated sample for further processing and/or analysis.

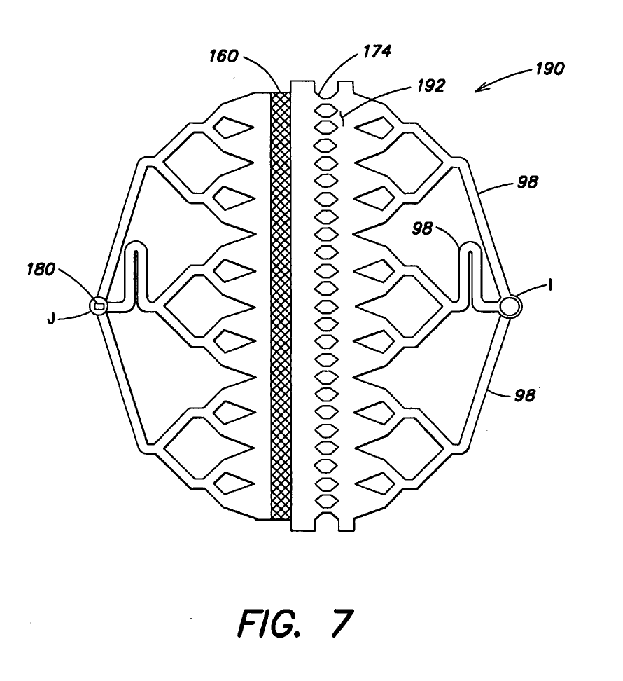

Turning to FIG. 7, another approach to creating a substantially uniform current density across a membrane is illustrated. Similar to some of the above-described embodiments, this concentrator system 190 includes a chamber 192 with at least one semi-permeable membrane 174. A sample may enter the chamber 192 through inlet port I. Once in the chamber 192, the sample may move through and branch out into the channels 98 which end at the membrane 174. The negatively charged sample may move from port I towards the membrane 174 due to an electric field which may be created with a positive electrode 180 positioned at port J and a negative electrode in a position upstream from the sample, such as at port I. Membrane 174 may be configured similar to the above-described membranes 24, 34, 94 such that as the sample is attracted to the positive electrode 58 at port J, the sample collects and concentrates onto the membrane 174.

In this particular embodiment shown in FIG. 7, there are no parallel channels as illustrated in FIGS. 2, 3 and 5. Instead, the embodiment illustrated in FIG. 7 includes a shallow depth region 160 positioned between the membrane 174 and the electrode 180 to alter the electrical resistance which may force current streamlines to spread more uniformly across the width of the membrane 174. As shown, in some embodiments, this shallow depth region 160 may extend substantially along the entire width of the membrane 174. This shallow depth region 160 may force the current to spread out more uniformly across the membrane 174, in comparison to an embodiment where the depth of region 160 is substantially the same as the depth of the surrounding chamber 192.

In one embodiment, the depth of the shallow depth region 160 (i.e. distance into the page) is approximately 50% of the depth of the surrounding chamber 192. In another embodiment, the depth of the shallow depth region 160 is approximately 25% of the depth of the surrounding chamber 192, and in another embodiment, the depth of the shallow depth region 160 is approximately 10% of the depth of the surrounding chamber 192, is approximately 5% of the depth of the surrounding chamber 192, or approximately 1% of the depth of the surrounding chamber 192. In one particular embodiment where the depth of the shallow depth region 160 is approximately 5% of the depth of the surrounding chamber 192, the depth of the chamber is approximately 20 micrometers and the depth of the shallow depth region is approximately 1 micrometer.

As discussed above, the concentrator system 190 may be formed into a microfluidic chip and the chambers 192 and channels 98 may be pre-etched into the chip, for example, with microlithographic manufacturing techniques. Similarly, a shallow depth region 160 may also be pre-etched into the chip.

It should be appreciated that although there are no parallel channels illustrated in the embodiment of FIG. 7, that in some embodiments, a shallow depth region 160 may be used with parallel channels as the invention is not limited in this respect.

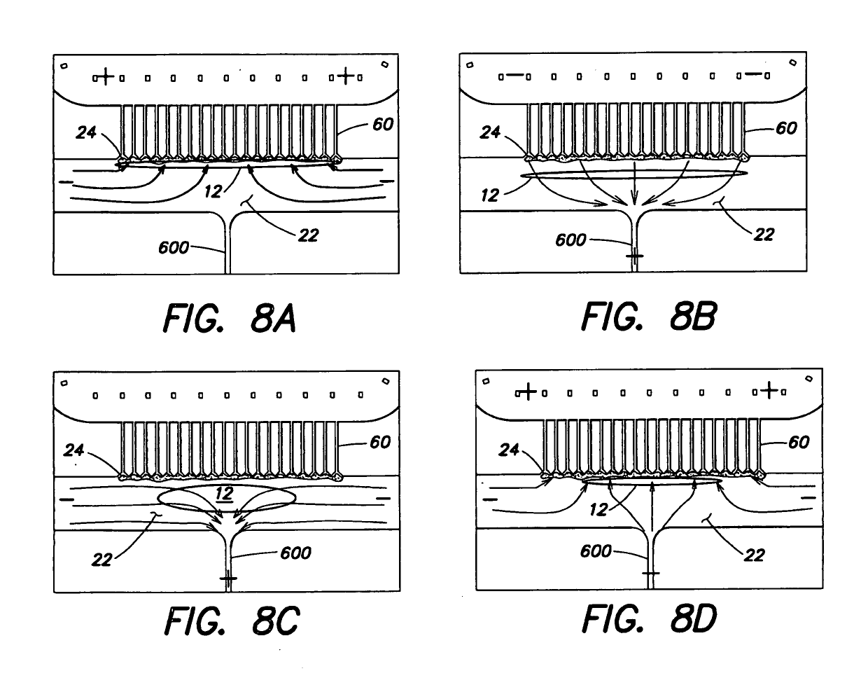

In some embodiments, systems and methods of transferring and concentrating a sample are provided to maintain the band integrity of the sample after the sample collects on a membrane 24. For example, as shown in FIGS. 8A-8D, a squeeze mode elution process is shown in greater detail which may prevent a sample from stretching out and losing bulk concentration as it is moved away from a membrane. In FIG. 8A, the sample 12 has collected on a sample contacting surface of a membrane 24. In this particular embodiment, the sample 12 moves toward a membrane 24 due to an electric field created across the membrane 24.

In this embodiment, a channel 600 is opposing the sample contacting surface of the membrane 24. In this particular embodiment, the channel 600 is substantially perpendicular to the chamber 22. In other embodiments, the channel 60 may have other angular orientations with respect to the chamber 22, such as, but not limited to approximately 30°, approximately 45°, or approximately 60°. As shown in FIG. 8B, an electric field is then created into the channel 600 opposing the sample contacting surface to move the negatively charged sample 12 away from the sample contacting surface and towards the channel 600. This electric field may only be applied for a short period of time (i.e. a few seconds) to substantially release the sample 12 from the membrane 24. Then, as shown in FIG. 8C, an electric field is created between the chamber 22 and channel 60 to compress the sample 12 in the chamber 22. This compression step “squeezes” the sample 12 together to help maintain the band integrity of the sample. In one embodiment, the electric field has a stronger component in the direction of the chamber 22 and a weaker component in the direction of the channel 60 such that the sample 12 is compressed inwardly. As shown in FIG. 8D, an electric field may then be created across the membrane 24 such that the negatively charged sample 12 moves back toward the sample contacting surface of the membrane.

This squeezing process may be repeated to further compress the sample. In one embodiment, the squeezing process may be repeated so that the portion of the sample 12 at each end is compressed inwardly toward the center of the sample. Then, when the sample is moved, the sample 12 is less dispersed and may be more likely to move in a uniform band. It is contemplated that the more the squeezing process is repeated, the greater the sample concentration. The squeezing process may be repeated until a desired sample concentration is reached. Once the squeezing process is completed, the sample 12 may be moved down either end of the chamber 22 or out through the channel 60.

It is also contemplated that the geometry of the chamber may be configured to maintain the band integrity of the sample. As shown in FIGS. 5 and 7, in some embodiments the chamber 92, 192 may include cone-shaped regions near the membrane 94, 174 which the sample travels through after the sample concentrates on the membrane. Applicants have discovered that the shape of the cone-shaped regions may affect the band integrity of the sample as the sample is moved through the chamber. In particular, the longer the taper of the cone-shaped region, the more uniform the electric field and the more uniform the transport path distance through the cone. Thus, with a longer cone taper, the sample may be more likely to maintain its concentration band. In contrast, the shorter the taper, the more non-uniform electric fields and the greater the differences in transport path distances. Thus, a shorter cone taper may cause the sample to de-concentrate (i.e. a band defining the sample concentration may broaden).

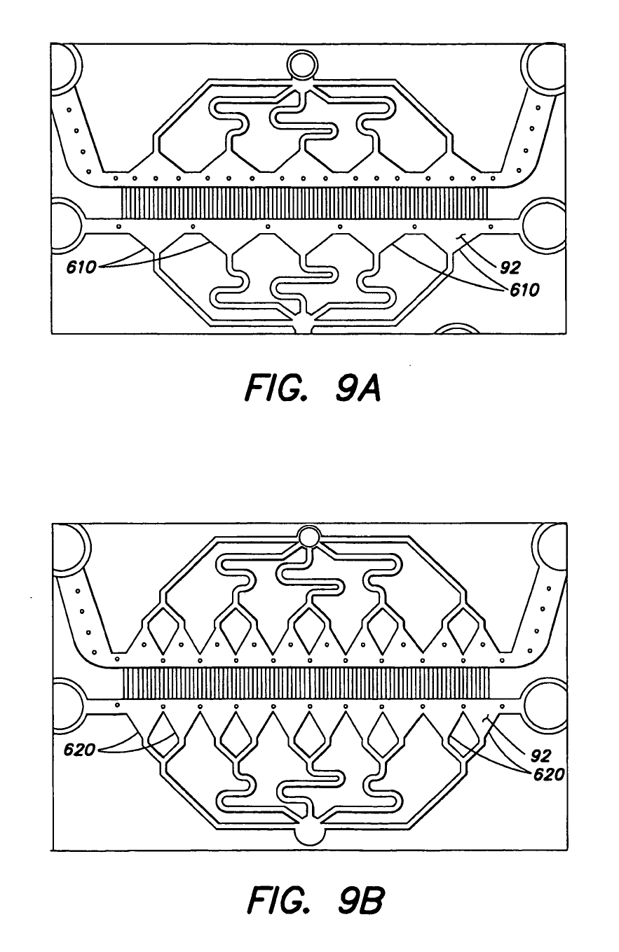

FIGS. 9A and 9B illustrate two different chamber configurations. In FIG. 9A, the chamber 94 includes 5 cone-shaped regions 610, whereas in FIG. 9B, the chamber 94 includes 10 cone-shaped regions 620 which have a longer taper. In certain embodiments, the chamber shown in FIG. 9B may provide a more uniform electric field and a more uniform sample travel distance due to this longer taper configuration.

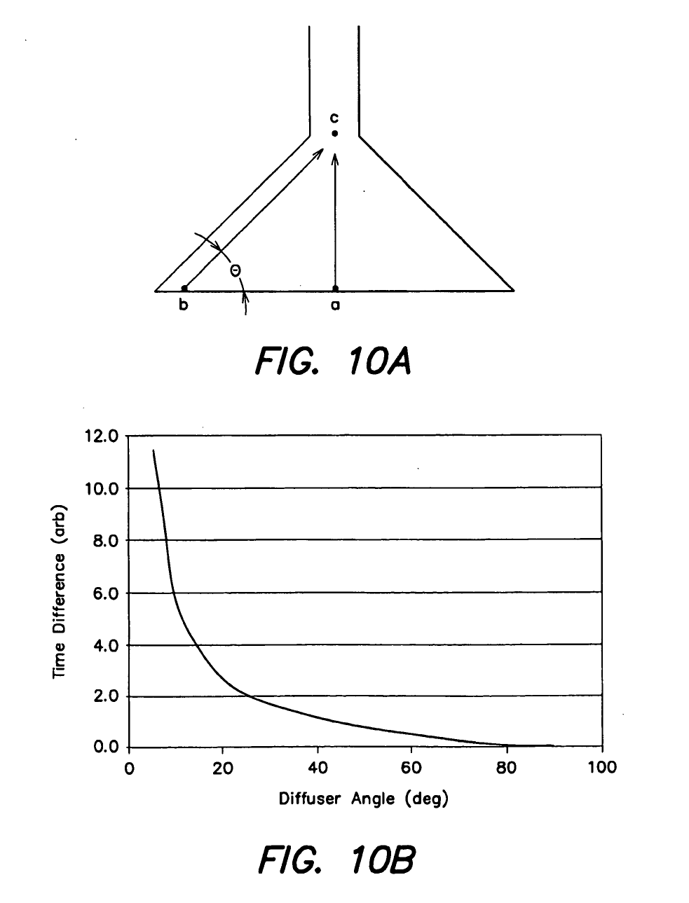

FIG. 10A illustrates the path that two sample molecules a and b may take to reach a destination point c through a cone-shaped region. As shown, molecule b must travel a greater distance in comparison to molecule a. The difference in distances is a function of the diffuser angle θ of the cone/funnel. FIG. 10B illustrates Applicants calculation results of the time difference between molecule a and molecule b versus the diffuser angle θ. Applicants discovered that a funnel/cone with an angle of approximately 25° will have approximately five times more band broadening in comparison to a funnel/cone with an angle of approximately 70°. As shown from the graph in FIG. 10B, at higher angles, diminishing returns are observed which would indicate that lengthening the taper angle beyond 70° may be of limited value.

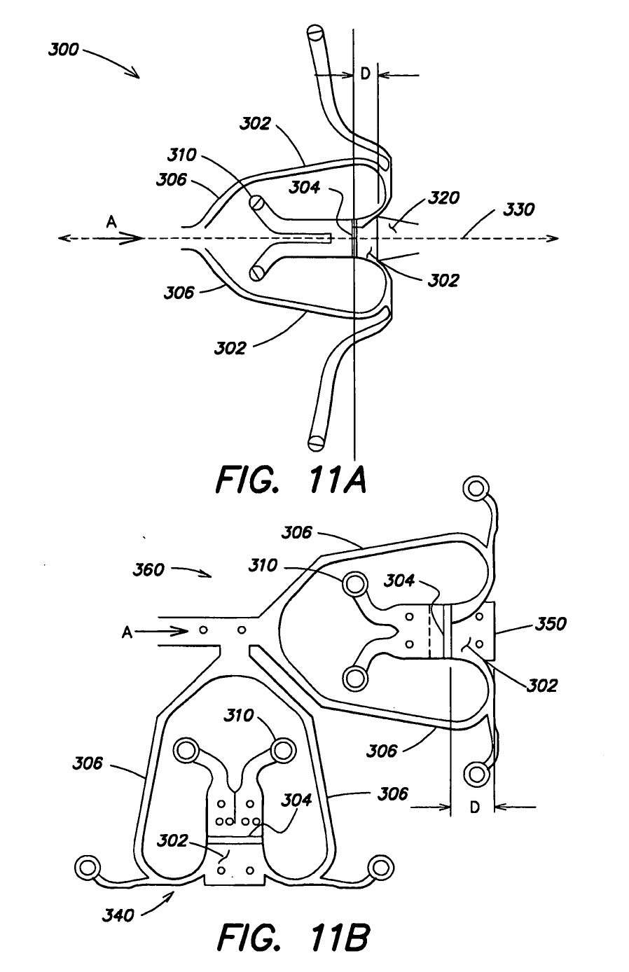

FIG. 11A illustrates yet another embodiment of a system for concentrating a sample. Like some of the above-described embodiments, this concentrator system 300 includes a chamber 302 with at least one semi-permeable membrane 304. A sample may enter the chamber 302 through the inlet represented by arrow A. In this embodiment, the chamber splits into a plurality of channels 306 which end at membrane 304. In one embodiment, the chamber 302 is bifurcated such that each channel 306 extends towards and past the membrane 304 and makes a U-shaped turn back toward the membrane 304. In this respect, the concentrator system 300 is symmetric about axis 330. It is contemplated that this bifurcated design may permit the sample to become more evenly distributed across the length of the membrane. The sample may move from the position of arrow A through either of the channels 306 towards the membrane 304 due to an electric field which may be created with a positive electrode 310 positioned at port L and a negative electrode (not shown) positioned upstream from the sample. Membrane 304 may be configured similar to the above-described membranes 24, 34 such that as the sample is attracted to the positive electrode 310 at port L, the sample collects and concentrates onto the membrane 304. Once the sample has concentrated on the membrane 304, the electric field may be reversed to move the sample away from the membrane for further processing in the downstream component 320.

As illustrated, the concentrator system 300 is arranged to minimize the distance between the membrane 304 and the downstream component 320. It may be desirable to minimize this distance to maintain the concentration of the sample after the sample leaves the membrane 304. In one embodiment, the distance D between the membrane 304 and the downstream component 320 is between approximately 0.5-1.0 mm, and may for example be less than 1 mm. In another embodiment, the distance D is between 1 mm-5 mm, and may for example be approximately 2.5 mm.

Although the size and shape of the channel 302 may vary, in one embodiment, the channel is pre-etched within a microfluidic chip and the depth of the channel 302 may be approximately 20 μm. In one embodiment, the adjacent downstream component 320 may be pre-etched within the chip and the depth of the downstream component 320 may be approximately 2 μm. In one embodiment, the location of the membrane 302 is pre-etched within a chip with a depth of approximately 1 μm.

FIG. 11B illustrates two concentrator systems 340, 360 that are similar to the above-mentioned concentrator system 300 and thus the various chambers, channels and membranes are given like reference numbers. In one embodiment, these concentrator systems 340, 360 may be positioned downstream of concentrator system 300. The sample may travel toward the two systems 340, 360 in the direction of arrow A due to an electric field.

In one embodiment, the electric field may oscillate between concentrator systems 340, 360 to more evenly distribute the sample across the two membranes 304. In other words, the electric field may be configured such that the sample first travels towards the membrane in the first system 340. The electric field may then switch to be configured such that the sample travels towards the membrane in the second system 360. This oscillating process may be repeated until the entire sample has been transferred to one of the two membranes 304. It should be appreciated that the oscillation rate may be adjusted to control the amount of the sample at each membrane. For example, if the oscillation rate is 50:50, the sample should be split approximately equally between the two membranes.

Thereafter, the sample on the membrane 304 in the first system 340 may be transferred to the membrane 304 in the second system 360. This process may be beneficial when the sample enters the two concentrator systems 340, 360 having been separated by sample size where it is desirable to recombine the various sample sizes back together. For example, in one embodiment, an upstream component may separate a nucleic acid sample such that the longer nucleic acids are clustered together and shorter nucleic acids are clustered together. By splitting up the sample onto the two membranes and thereafter combining the sample together, one may recombine the longer and shorter nucleic acids back together in a more evenly distributed mixture.

As mentioned above, it may be desirable to minimize the distance D between the membrane 304 and the downstream component 350. In one embodiment, the distance D is between approximately 0.5-5.0 mm, and may for example be approximately 2.5 mm.

### Transferor System

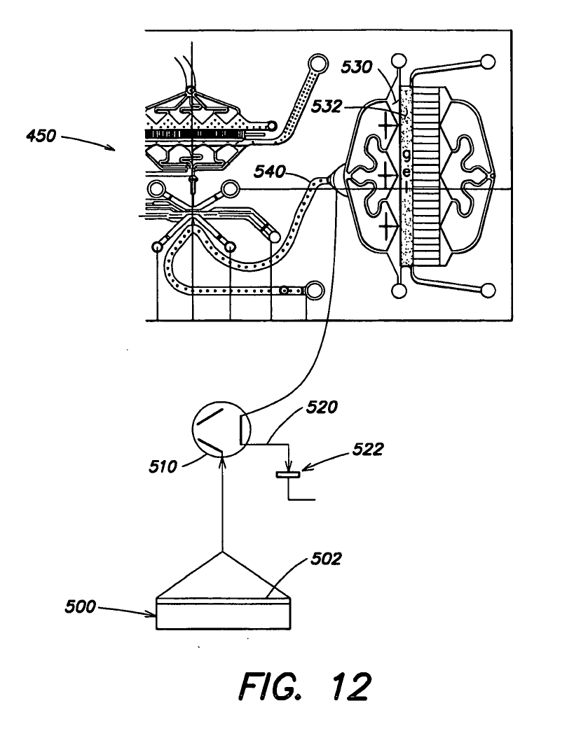

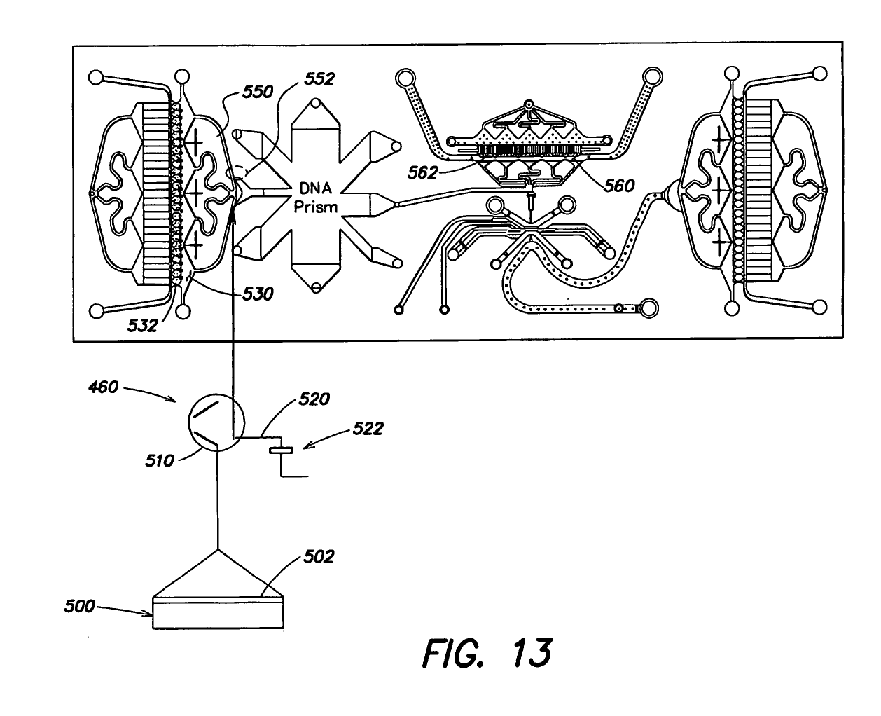

Turning now to FIGS. 12 and 13, a couple of embodiments of systems for transferring a sample are illustrated. As shown in FIG. 12, in one embodiment, a system 450 includes a reaction chamber 500, a downstream switching valve 510 and a first membrane 522 positioned within a first chamber 520. A sample may be initially positioned on a reaction chamber membrane 502. An assembly is provided to move the sample away from the reaction chamber membrane 502 to a sample contacting surface on the first membrane 522. In one embodiment, the assembly hydrodynamically moves the sample to the first membrane 522. For example, in one embodiment, the flow rate used to hydrodynamically move the sample is approximately 20 uL/min. In another embodiment, the assembly includes an electrode assembly configured to selectively create an electric field across the first membrane to move the sample.

Once the sample has collected on the first membrane 522, an electrode assembly is provided to transfer the sample back through the switch valve 510 and onto a second sample contacting surface of a second membrane 532 positioned within a second chamber 530 which is in selective fluid communication with the first chamber. The assembly is also configured to move a sample at least partially through the second chamber from an intermediate position to the second sample contacting surface. In particular, the assembly includes an electrode assembly configured to selectively create an electric field across the second membrane to move a sample to the second sample contacting surface. In one embodiment, the current used to move the sample from the first membrane 522 to the second membrane 532 is approximately 25 uA.

The membranes 502, 522, 532 may be made and formed using any of the above-described materials and methods. In one embodiment, the reaction chamber membrane 502 and the first membrane 522 are made of a cellulose membrane and the second membrane 532 is made of a polyacrylamide gel.

Also, as discussed above, in certain embodiments, the area of the first sample contacting surface of the first membrane 522 is greater than the area of the second sample contacting surface of the second membrane 532. For example, in one embodiment, the area of the first sample contacting surface of the first membrane 522 is approximately 10 mm² and the area of the second sample contacting surface of the second membrane 532 is approximately 0.4 mm², such that the ratio between the two surfaces is approximately 25. In one embodiment, the sample contacting surface of the reaction chamber membrane 502 is approximately 100 mm², such that the ratio between this surface and the downstream first sample contacting surface of the first membrane 522 is approximately 10.

Once the sample is transferred to the second membrane 532, the sample may be transferred with the electrode assembly to downstream locations. For example, in one embodiment, the sample may be transferred to chamber 540 for further processing which may, for example, include stretching the sample.

As shown in FIG. 13, in other embodiments, a system 460 is provided to transfer a sample which includes more downstream membranes. Similar to the embodiment shown in FIG. 12, the system 460 shown in FIG. 13 also includes a reaction chamber 500, a downstream switching valve 510 and a first membrane 522 positioned within a first chamber 520. Once the sample is moved away from the reaction chamber membrane 502 and to a sample contacting surface on the first membrane 522, an electrode assembly may be provided to transfer the sample to a second membrane 532 positioned within a second chamber 530. Thereafter, the sample may be transferred to a third membrane 552 in a third chamber 550 and then to a fourth membrane 562 positioned in a fourth chamber 560.

It should be appreciated that in some embodiments the system 450,460 may be used primarily to transfer a sample. In other embodiments, the system 450, 460 may be used to transfer and concentrate the sample. Accordingly, many of the features described above with respect to concentrator systems may be interchangeably used with a transferor systems 450, 460, as the invention is not limited in this respect.

In one embodiment, one or more of the above-mentioned systems for transferring and/or concentrating a sample may be used to perform a reaction on the sample, in the absence or presence of transferring or concentrating. A reaction, as used herein, is a covalent or non-covalent modification of a sample, or more usually components of a sample. A covalent modification means that a covalent bond is broken and/or formed. A non-covalent modification means any other type of modification. The reaction may be a chemical or biological reaction. In one embodiment, the reaction is performed on a nucleic acid sample.

In one embodiment, a reaction may be performed by placing a sample within the first chamber of one of the above-mentioned systems. The sample may comprise a nucleic acid and/or other biological material. When the sample is negatively charged, such as with a nucleic acid sample, an electric field is created with the electrode assembly across the first membrane such that a charged component of the sample moves to the first sample contacting surface. It should be appreciated that the sample as a whole may not be negatively charged. One or more reagents are placed within the first chamber and a reaction is performed between the sample and the one or more reagents. It should also be appreciated that similar reactions may be performed in the second chamber on the second membrane, as the invention is not limited in this respect.

The reaction may be performed in a variety of ways. In one embodiment, the reaction may be performed by creating an electric field with the electrode assembly across the first membrane such that the reagent(s) moves to the first sample contacting surface to react with the sample. In another embodiment, the reaction may be performed by hydrodynamically moving the reagent(s) to the first sample contacting surface to react with the sample. After the reaction, excess reagent(s) may be flushed out of the chamber by flowing a buffer solution across the surface of the membrane. In one embodiment, a plurality of reactions may be performed on the membrane. Once the series of one or more of the reactions is complete, the electric field may be reversed to transfer the sample to a downstream component for further processing of the sample.

A reaction may be performed with various types of reagents. The reagent may include at least one of fluorescent intercalating dyes, bisPNA tags, restriction endonucleases, and DNA-binding reagents. For example, in one embodiment, the reagent may be an intercalating dye and the sample may be a DNA sample and the reaction may facilitate fluorescent detection of the DNA molecule in a subsequent step.

### Pipette

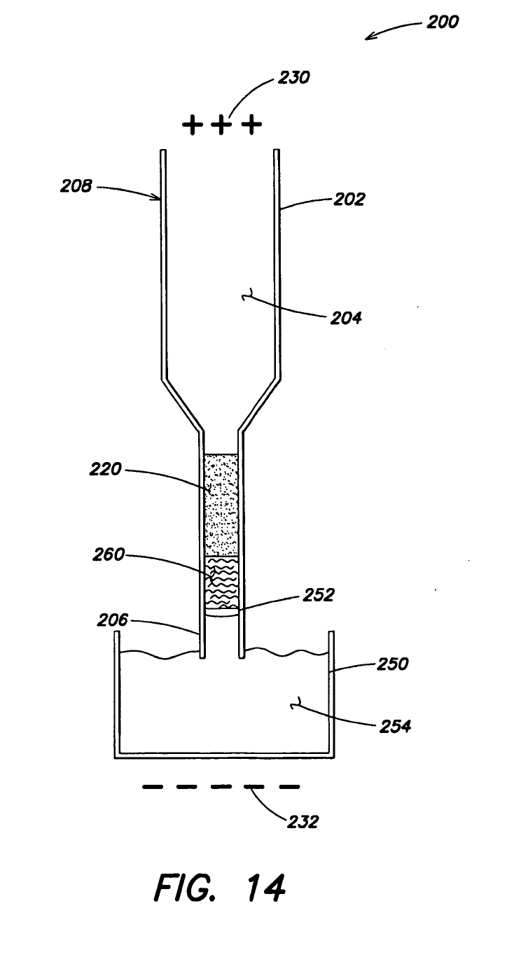

Turning now to FIG. 14 a pipette according to one embodiment for concentrating, and/or transferring a sample is illustrated. The pipette 200 includes a body 202 having a passageway 204 therethrough. A semi-permeable membrane 220 is positioned within the passageway 204 such that the membrane 220 is spaced apart from a first end 206 of the body. The passageway 204 is filled with a conductive buffer solution, such as Tris/Borate/EDTA(TBE) or Tris/Acetate/EDTA(TAE). A positive electrode 230 is positioned at the second end 208 of the body, and may selectively create an electric field through the passageway to the first end 206 of the body when used in association with a negative electrode 232. In some embodiments, the positive electrode is positioned within the body 202, whereas in other embodiments, as shown in FIG. 6, the positive electrode is positioned outside of, but in proximity to the body 202, such that the electrode 230 may selectively create an electric field through the body 202. In one embodiment, the electrode 230 is formed from a wire placed within the conductive buffer. However, in other embodiments, the electrodes may be configured differently, as the invention is not so limited.

According to one particular method, the first end 206 of the pipette 200 is placed in contact with a negatively charged nucleic acid sample contained within a reservoir 250. An electric field is created through the passageway 204 of the pipette 200 between the positive and negative electrodes 230, 232. Under the electric field, a first portion 252 of the negatively charged nucleic acid sample 254 is drawn into the first end 206 of the pipette body 202 to concentrate the first portion of the sample in the pipette 200, where the concentration of nucleic acid of the first portion 252 is greater than the concentration of nucleic acid of the reservoir nucleic acid sample 254.

The negative electrode 232 may be positioned proximate to the first end 206 of the body. In one embodiment, the negative electrode 232 may be adjacent to or within the reservoir 250. The pipette 200 may be used to withdraw a small sample 252 from a larger volume of the sample 254 contained within the reservoir 250. Once drawn into the pipette 200, the sample may concentrate against the membrane 220 as discussed above. It should be recognized that when the negative electrode 232 is within the reservoir 250, a physical barrier (not shown) may be provided between the electrode 232 and the sample to prevent direct contact but still permit electrical contact, as direct contact may cause a detrimental electro-chemical reaction.

The pipette 200 may also be used to separate a charged sample from a non-charged or oppositely charged material. When the electric field is created through the pipette 200, the charged sample may be attracted into the pipette 200, leaving the non-charged or oppositely charged material outside of the pipette.

The pipette 200 may be used to transfer a sample between two locations that are not in fluid communication with each other (i.e. remote), for example, between two spaced apart reservoirs. For example, in one particular embodiment, a first portion 252 of a negatively charged sample 254 is drawn up into the pipette 200 from a reservoir 250 due to the electric charge. Thereafter, the first portion 252 of the sample may be dispensed into another reservoir (not shown) by either moving the first end 206 of the pipette 200 to a second reservoir or by moving a second reservoir over to the pipette 200.

In one embodiment, the portion 252 of the sample is also dispensed from the pipette 200 using an electric field. For example, the negatively charged sample may be dispensed from the pipette by reversing the electric field (i.e., an electric field is created between a negative electrode positioned at the second end 208 of the body and a positive electrode is positioned proximate the first end 206 of the body). In another embodiment, the portion 252 of the sample may be dispensed from the pipette 200 hydrodynamically using mechanical approaches such as using a pump. It should be appreciated that in embodiments where the sample is more fragile, such as, for example, when the sample is a nucleic acid sample which includes long DNA segments, dispensing the sample with an electric field may be desirable to prevent damaging the sample due to shear forces. In one embodiment, a first portion 252 of the sample is drawn into and dispensed from the pipette 200 without substantially shearing the nucleic acids.

The semi-permeable membrane 220 is conductive, such that an electric field may travel through the membrane. The membrane may be porous, but the membrane is configured such that the sample, such as a nucleic acid sample, cannot easily pass completely through the membrane 220. In one embodiment, the membrane 220 is substantially resistant to the flow of nucleic acids through the membrane 220. As discussed further below, the membrane 220 may be configured such that a sample, such as a nucleic acid sample, may pass partially into but not completely through the membrane. In one embodiment, the membrane 220 may be formed from a semi-solid material, and may for example, be made from a dense polymer matrix. In one embodiment, the membrane 220 is formed from a 20% solution of acrylimide which acts as a plug within the passageway to substantially limit the flow of a sample from the first end 206 to the second end 208.

The membrane 220 may also be formed in a variety of ways. In one embodiment, a membrane is a semi-permeable polymer membrane formed from a material such as a gel matrix plug. For example, the gel matrix plug may be formed with an acrylimide gel or agarose gel which may be formed within the pipette passageway 204 using one of the methods and techniques described above. In yet other embodiments, the membrane may be formed by a regenerated cellulose material. As discussed above, in some embodiments, joule heating caused by the electric field may affect a membrane formed from a gel. In some embodiments, a membrane formed from regenerated cellulose filter paper may be less affected by joule heating.

The pipette body 202 may be made of a variety of materials, as the invention is not limited in this respect. In one particular embodiment, the pipette body 202 is made from a plastic or glass, and the body 202 may include a surface treatment to change the surface from a polar to a non-polar surface. The dimensions of the pipette 200 may vary according to different applications, as the invention is not so limited. However, in one embodiment, the pipette 200 has a height of between approximately 4-5 inches, with a diameter of approximately 0.5 inches. The tip of the pipette at the first end 206 may taper down such that the diameter at the first end 206 is within approximately 0.5 mm.

The pipette 200 may include a layer 260 positioned within the passageway 204 adjacent the semi-permeable membrane 220 and proximate the first end 206 of the body. In this embodiment, a sample 252 drawn into the first end 206 of the pipette will collect and concentrate on the layer 260 and may not directly contact the membrane 220. This additional layer 260 is conductive, such that an electric field may travel through the layer, and the layer 260 may act as a cushion as the sample 252 is drawn into the pipette 200. The layer 260 may prevent the sample from becoming embedded within the membrane 220. The layer 260 may be less dense than the buffer solution such that the layer 260 floats up and/or remains adjacent to the membrane 220. In one embodiment, the layer 260 includes an electrically conductive solvent layer which forms a separate phase when mixed with a fluid, such as water. In one embodiment, the layer 260 is an organic solvent layer, and may for example be made of butanol. The thickness of the layer 260 may be between approximately 5 mm-1 cm. When the layer 260 is too thin, in some embodiments, the sample 252 may tend to get trapped within the membrane 220, and when the layer is too thick, the resistance within the passageway of the pipette may build up due to joule heating. It should be recognized that although this layer 260 is shown with respect to the pipette 200 that in other embodiments, the layer 260 may be provided adjacent a membrane in any one of the above-described systems, as the invention is not limited in this respect.

In one particular embodiment, a pipette 200 is able to concentrate a nucleic acid sample which includes elongated DNA segments having a length of between approximately 100 kilobase and 1 megabase. Such samples my be concentrated within the pipette 200 up to 10 times or even 20 times the sample concentration within the reservoir 250 without substantially shearing and thus damaging the sample.

It should be appreciated that in one embodiment, the pipette 200 may be used individually, while it is also contemplated that a plurality of pipettes 200 may be used simulataneously, as the invention is not so limited.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for concentrating a sample, the system comprising:
a first concentrator, the first concentrator comprising:
a first chamber;
a first semi-permeable membrane positioned within the first chamber, the first membrane having a first sample contacting surface;
an electrode assembly configured to selectively create an electric field across the first membrane to move a sample at least partially through the first chamber, from a starting position to the first sample contacting surface;
a second concentrator positioned downstream of the first concentrator, the second concentrator comprising:
a second chamber, wherein the second chamber is in selective fluid communication with the first chamber;
a second semi-permeable membrane positioned within the second chamber, the second membrane having a second sample contacting surface;
wherein the electrode assembly is also configured to selectively create an electric field across the second membrane to move a sample at least partially through the second chamber from an intermediate position to the second sample contacting surface; and
wherein the area of the first sample contacting surface is greater than the area of the second sample contacting surface.

2. The system of claim 1, wherein the ratio between the first sample contacting surface and the second sample contacting surface is at least approximately 2.

3. The system of claim 2, wherein the ratio between the first sample contacting surface and the second sample contacting surface is at least approximately 10.

4. The system of claim 3, wherein the ratio between the first sample contacting surface and the second sample contacting surface is at least approximately 20.

5. The system of claim 1, wherein the electrode assembly comprises:
a first electrode configured to selectively create an electric field across the first membrane; and
a second electrode configured to selectively create an electric field across the second membrane.

6. The system of claim 1, wherein the first and second membranes are polymer membranes.

7. The system of claim 1, further comprising a starting membrane in a reaction chamber positioned upstream of the first concentrator, wherein the starting membrane defines the sample starting position.

8. The system of claim 1, further comprising a plurality of substantially parallel microchannels outwardly extending from at least a portion of the first chamber, wherein the first membrane extends along the plurality of microchannels such that an electric field is selectively created through the plurality of microchannels.

9. The system of claim 8, wherein the plurality of substantially parallel microchannels includes a first set of substantially parallel microchannels and a second set of substantially parallel microchannels, wherein the first and second set are positioned on opposing sides of the first chamber.

10. The system of claim 1, further comprising a plurality of substantially parallel microchannels outwardly extending from at least a portion of the second chamber, wherein the second membrane extends along the plurality of microchannels such that an electric field is selectively created through the plurality of microchannels.

11. The system of claim 1, wherein the first concentrator is formed on a first micro-fluidic chip and the second concentrator is formed on a second micro-fluidic chip.

12. The system of claim 11, wherein the first concentrator includes a shallow depth region positioned between the first membrane and the electrode assembly such that the electric field is selectively created through the shallow depth region.

13. A method of transferring and concentrating a sample, the method comprising acts of:
providing the system for concentrating a sample as recited in claim 1;
creating an electric field with the electrode assembly across the first membrane such that a negatively charged sample moves from a starting position to the first sample contacting surface, whereby the concentration of the sample is greater on the first sample contacting surface than at the starting position.

14. The method of claim 13, further comprising the act of:
reversing the electric field to remove the negatively charged sample from the first sample contacting surface.

15. The method of claim 13, wherein the sample is a charged nucleic acid sample.

16. A system for concentrating a sample, the system comprising:
a chamber having an inlet port;
a plurality of substantially parallel microchannels outwardly extending from the channel;
a semi-permeable membrane extending within the chamber, the membrane having a first sample contacting surface, wherein the membrane extends along the plurality of microchannels;
an electrode assembly configured to selectively create an electric field through the plurality of microchannels and across the membrane to move a sample at least partially through the chamber, from a starting position to the first sample contacting surface.

17. The system of claim 16, wherein the membrane extends at least partially into the plurality of microchannels.

18. The system of claim 16, wherein the membrane is spaced apart from the plurality of microchannels.

19. The system of claim 18, further comprising a backside flow branch positioned between the membrane and the microchannels to provide fluid flow adjacent the membrane.

20. The system of claim 16, wherein the membrane is a polymer membrane.

21. The system of claim 16, wherein the chamber and the plurality of microchannels are pre-etched into a microfluidic chip.

22. The system of claim 16, wherein the plurality of microchannels are arranged to create a substantially uniform current density across the membrane when the electrode assembly creates an electric field.

23. The system of claim 16, further comprising a channel opposing the first sample contacting surface, wherein the electrode assembly is configured to selectively create an electric field into the channel opposing the first sample contacting surface to move a sample away from the first sample contacting surface.

24. A pipette, comprising:
a body having a passageway therethrough, the body having a first end and a second end;
a semi-permeable membrane positioned within the passageway, the semi-permeable membrane being spaced apart from the first end of the body;
an electrolytic buffer solution within the passageway; and
a positive electrode positioned at the second end of the body, wherein the positive electrode may selectively create an electric field through the passageway to the first end of the body when used in association with a negative electrode.

25. The pipette of claim 24, wherein the semi-permeable membrane is formed by a gel matrix plug.

26. The pipette of claim 24, wherein the semi-permeable membrane is formed by a regenerated cellulose membrane.

27. The pipette of claim 24, further comprising an organic solvent layer positioned within the passageway adjacent the semi-permeable membrane and proximate the first end of the body.

28. The pipette of claim 26, wherein the organic solvent layer is butanol.

29. The pipette of claim 25, wherein the gel matrix plug is formed with an acrylimide gel.

30. The pipette of claim 24, wherein the semi-permeable membrane is substantially resistant to the flow of a nucleic acid through the semi-permeable membrane.

31. The pipette of claim 24, further comprising a negative electrode positioned proximate the first end of the body, wherein the negative electrode and positive electrode create an electric field through the passageway.

32. The pipette of claim 24, wherein the positive electrode is positioned within the body.

33. A method of transferring and concentrating a sample, the method comprising acts of:
providing a pipette having a body with a passageway therethrough, a semi-permeable membrane positioned within the passageway, and an electrolytic buffer solution within the passageway;
placing a first end of the pipette in contact with a negatively charged sample contained within a reservoir; and
creating an electric field through the passageway of the pipette body such that a first portion of the negatively charged sample is drawn into a first end of the pipette body, whereby the concentration of the first portion of the sample is greater than the concentration of the sample in the reservoir.

34. The method of claim 33, further comprising the act of:
reversing the electric field to dispense the first portion of the negatively charged sample from the pipette.

35. The method of claim 33, further comprising the act of:
hydrodynamically dispensing the first portion of the negatively charged sample from the pipette.

36. The method of claim 33, wherein placing a first end of the pipette in contact with the negatively charged sample contained within the reservoir comprises placing the first end of the pipette in contact with a reservoir of a nucleic acid sample.

37. The method of claim 36, wherein the first portion of the sample includes nucleic acids and the first portion is drawn into a first end of the pipette body without substantially shearing the nucleic acids.

38. A system for transferring a sample, the system comprising:
a first chamber;
a first semi-permeable membrane positioned within the first chamber, the first membrane having a first sample contacting surface;
an assembly configured to move a sample at least partially through the first chamber, from a starting position to the first sample contacting surface;
a second chamber, wherein the second chamber is in selective fluid communication with the first chamber;
a second semi-permeable membrane positioned within the second chamber, the second membrane having a second sample contacting surface;
wherein the assembly is also configured to move a sample at least partially through the second chamber from an intermediate position to the second sample contacting surface, wherein the assembly includes an electrode assembly configured to selectively create an electric field across the second membrane to move a sample to the second sample contacting surface; and
wherein the area of the first sample contacting surface is greater than the area of the second sample contacting surface.

39. The system of claim 38, wherein the assembly includes an electrode assembly configured to selectively create an electric field across the first membrane to move a sample to the first sample contacting surface.

40. The system of claim 38, wherein the assembly hydrodynamically moves a sample to the first sample contacting surface.

41. The system of claim 38, further comprising:
a third chamber, wherein the third chamber is in selective fluid communication with the second chamber;
a third semi-permeable membrane positioned within the third chamber, the third membrane having a third sample contacting surface;
wherein the assembly is also configured to move a sample at least partially through the third chamber from an intermediate position to the third sample contacting surface, wherein the electrode assembly is configured to selectively create an electric field across the third membrane to move a sample to the third sample contacting surface.

42. The system of claim 41, wherein the area of the second sample contacting surface is greater than the area of the third sample contacting surface.

43. A method of transferring and concentrating a sample, the method comprising acts of:
providing a chamber with a semi-permeable membrane positioned within the chamber, with the membrane having a sample contacting surface, and a channel opposing the sample contacting surface;
placing a negatively charged sample within the chamber;
creating an electric field across the membrane such that the negatively charged sample is drawn through the chamber and to the sample contacting surface of the membrane;
creating an electric field into the channel opposing the sample contacting surface to move the negatively charged sample away from the sample contacting surface and towards the channel; and
creating an electric field between the chamber and the channel to compress the sample in the chamber.

44. The method of claim 43, further comprising the acts of:
creating an electric field across the membrane such that the negatively charged sample moves back toward the sample contacting surface; and
creating an electric field between the chamber and the channel to compress the sample.

45. A method of performing a reaction with a sample, the method comprising acts of:
providing the system as recited in claim 39;
placing a sample within the first chamber;
creating an electric field with the electrode assembly across the first membrane such that a sample moves to the first sample contacting surface;
placing a reagent within the first chamber; and
performing a reaction with the sample and the reagent.

46. The method of claim 45, wherein performing a reaction with the sample and the reagent comprises creating an electric field with the electrode assembly across the first membrane such that the reagent moves to the first sample contacting surface to react with the sample.

47. The method of claim 45, wherein performing a reaction with the sample and the reagent comprises hydrodynamically moving the reagent to the first sample contacting surface to react with the sample.

48. The method of claim 45, further comprising:
flushing excess reagent out of the first chamber.

49. The method of claim 45, wherein the reaction is a chemical reaction.

50. The method of claim 45, wherein the reaction is a biological reaction.

51. The method of claim 45, wherein the reagent includes at least one of fluorescent intercalating dyes, bisPNA tags, restriction endonucleases, and DNA-binding reagents.

52. The method of claim 45, wherein the sample comprises nucleic acids.
